(19) United States
(12) Patent Application Publication
(10) Pub. No.: US 2007/0104098 A1
(43) Pub. Date: May 10, 2007

(54) RADIO FREQUENCY SIGNAL PROCESSING DEVICE AND MOBILE COMMUNICATION TERMINAL EQUIPPED WITH THE DEVICE

(76) Inventors: Yasuyuki Kimura, Tokyo (JP); Yasuo Shima, Tokyo (JP); Noriyuki Kurakami, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/555,954

(22) Filed: Nov. 2, 2006

(30) Foreign Application Priority Data
Nov. 10, 2005 (JP) 2005-325618

(51) Int. Cl. H04L 12/26

(52) U.S. Cl. 370/229

(57) ABSTRACT

An RF signal processing integrated circuit has a first operation mode in which the operation setting of a time slot is executed using one time slot as one setting unit and a second operation mode in which the operation setting of a time slot is executed using plural time slots as one setting unit. In which mode the circuit is set is determined according to bit information contained in an instruction for the initialization, the mode setting, or the time slot setting. It is thus possible to enhance the degree of freedom in the operation setting of a time slot in a mobile communication terminal capable of making communications with the base station by a communication method employing the time-division multiple access (TDMA) method.

### CROSS-REFERENCE TO RELATED APPLICATIONS

The disclosure of Japanese Patent Application No. 2005-325618 filed on Nov. 10, 2005 including the specification, drawings, and abstract is incorporated herein by reference in its entirety.

### BACKGROUND OF THE INVENTION

1. Field of the Invention

The present invention relates to a technique useful in enhancing the degree of freedom in the operation setting of a time slot in a mobile communication terminal capable of making communications with a base station by a communication method employing the TDMA (Time-Division Multiple Access) method by which each time slot among plural time slots can be set in any one of an idle state, a reception operation from the base station, and a transmission operation to the base station.

2. Description of Related Art

The TDMA method has been used, by which each time slot among plural time slots can be set in any one of an idle state, a reception operation from the base station, and a transmission operation to the base station. TDMA is an abbreviation of time-division multiple access. The GSM (Global System rates for Mobile communication) method that uses the phase modulation alone is known as one type of the TDMA method. Meanwhile, there is a method achieving an improved communication data transfer rate in comparison with the GSM method. Recently, as such an improved method, attention has been focused on the EDGE (Enhanced Data for GSM Evolution: Enhanced Data for GPRS) method that uses not only the phase modulation but also the amplitude modulation. GPRS is an abbreviation of general packet radio service.

Both the GSM method and the EDGE method are introduced in Michael R. Elliott et al, “A Polar Modulator Transmitter for GSM/EDGE”, IEEE JOURNAL OF SOLID-STATE CIRCUITS, VOL. 39 NO. 12, DECEMBER, 2004, pp. 2190-2199.

The inventors conducted a study of the operation setting method of a time slot in an RF IC while they were developing an RF IC as an RF signal processing device that supports the GSM method employing the TDMA method, and achieved the following conclusion.

The RF IC employing the TDMA method developed to date by the applicant of the invention of the present application adopts the operation setting method of a time slot as follows. That is, when each time slot among plural time slots in an RF IC conforming to the TDMA method is set in any one of an idle state, a reception operation from the base station, and a transmission operation to the base station, one time slot is used as one setting unit. More specifically, the operation of a time slot in the RF IC is set in response to the information supplied from a device equipped to a mobile communication terminal and performing baseband digital signal processing. One time slot is the only setting unit for the operation setting of a time slot. In other words, for a device in the related art (baseband LSI) that performs the baseband digital signal processing, one time slot alone is the setting unit for the operation setting of a time slot in the RF IC.

Meanwhile, the inventors also conducted a study of another method for equipping a mobile communication terminal with a device (baseband LSI) capable of using plural time slots as the setting unit for the operation setting of plural time slots in an RF IC conforming to the TDMA method and performing the baseband digital signal processing. Expectations are expanding for a possibility of reducing a load during transfer of information data for the operation setting from the baseband LSI to the RF IC by adopting the method of the operation setting of a time slots according to this another method.

The inventors, however, found the fact as follows from their studies of the circumstances described above. That is, assume that what has been described above is feasible, then, there will be two types of baseband LSI: a type in which the setting unit of the operation setting of a time slot is limited to one time slot alone, and another type in which the setting unit of the operational setting of a time slot is limited to plural time slots. Developing, designing, and mass-producing these two types of baseband LSI would become a significant burden. In addition, developing, designing, and mass-producing RF IC's corresponding to these two types of baseband LSI would also become a significant burden.

### SUMMARY OF THE INVENTION

The invention was devised on the basis of the result of the studies conducted by the inventors as described above, and therefore has an object to enhance the degree of freedom in the operational setting of a time slot in a mobile communication terminal capable of making communications with the base station by a communication method employing the time-division multiple access method.

The summary of a representative invention disclosed in the present application can be briefly described as follows.

That is, one aspect of the invention is an RF signal processing device (300) serving as a second device that is equipped to a mobile communication terminal capable of making communications with a base station by a communication method employing time-division multiple access by which each time slot among plural time slots is set in any one of an idle state, a reception operation from the base station, and a transmission operation to the base station. The RF signal processing device (300) as the second device is electrically connectable to a first device (400) that performs baseband digital signal processing and is equipped to the mobile communication terminal The second device (300) has a first operation mode (FOPMOD) in which a setting operation of a time slot is executed using one time slot as one setting unit in response to information supplied from the first device (400). The second device (300) also has a second operation mode (SOPMOD) in which a setting operation of a time slot is executed using plural time slots as one setting unit in response to information supplied from the first device (400). The second device (300) is selectively set in either one of the first operation mode (FOPMOD) and the second operation mode (SOPMOD).

The summary of another representative invention can be briefly described as follows.

That is, another aspect of the invention is a mobile communication terminal capable of making communications with a base station by a communication method employing time-division multiple access by which each time slot among plural time slots is set in any of an idle state, a reception operation from the base station, and a transmission operation to the base station. A first device (400) that performs baseband digital signal processing and is equipped to the mobile communication terminal and a second device (300) that performs RF signal processing are electrically connectable to each other. The second device (300) has a first operation mode (FOPMOD) in which a setting operation of a time slot is executed using one time slot as one setting unit in response to information supplied from the first device (400). The second device (300) also has a second operation mode (SOPMOD) in which the setting operation of the time slot is executed using plural time slots as one setting unit in response to information supplied from the first device (400). The second device (300) is selectively set in either one of the first operation mode (FOPMOD) and the second operation mode (SOPMOD).

According to either of the two means described above, the first device (400) that performs the baseband digital signal processing first executes either the first operation mode (FOPMOD) or the second operation mode (SOPMOD) when the operation setting of a time slot in the TDMA is executed. Nevertheless, the operation of the second device (300) that performs the RF signal processing is set so as to adapt to the executed mode. In this manner, it is possible to enhance the degree of freedom in the operation setting of a time slot in a mobile communication terminal capable of making communications with the base station by a communication method employing the time-division multiple access method.

In a concrete embodiment of the invention, the second unit (300) that performs the RF signal processing includes an interface (311 and 312). The interface receives the information (L1, L2, and L3) supplied for the first operation mode (FOPMOD) and the information (L4) supplied for the second operation mode (SOPMOD) from the first device (400) that performs the baseband digital signal processing.

In a more concrete embodiment of the invention, the second device (300) includes a memory (3101) that stores an instruction code and control information to execute an instruction for a set operation of a time slot, which are supplied as the information for the second operation mode (SOPMOD) from the first device (400) via the interface (311 and 312). The second device (300) further includes an RF signal processing sub-device (301 and 302) that performs the RF signal processing. The set operation of the time slot is booked in the memory (3101). Then, order information (WRD 6-3, 6-4, and 6-5) that determines in which order in the time slot the instruction code and the control information to execute the instruction booked in the memory (3101) are supplied to the RF signal processing sub-device (301 and 302) is supplied from the first device (400). The setting operation of the time slot in the second operation mode (SOPMOD) is thus executed.

In another more concrete embodiment of the invention, the second device (300) includes a memory (3101) that stores the instruction code and the control information to execute an instruction for a set operation of a time slot, which are supplied as the information for the second operation mode (SOPMOD) from the first device (400) via the interface (311 and 312). The second device (300) further includes an RF signal processing sub-device (301 and 302) that performs the RF signal processing. The set operation of the time slot is booked in the memory (3101). Then, timing information (L5 and Strb) that determines at which timing in the time slot the instruction code and the control information to execute the instruction booked in the memory (3101) are supplied to the RF signal processing sub-device (301 and 302) inside the second device (300) is supplied from the first device (400). The setting operation of the time slot in the second operation mode (SOPMOD) is thus executed.

In still another more concrete embodiment of the invention, the RF signal processing sub-device (301 and 302) is furnished with a function conforming to both a GSM method and an EDGE method.

In still another more concrete embodiment of the invention, when the set operation of the time slot is set in the first operation mode (FOPMOD), the instruction code and the control information (L1) to execute the instruction are supplied to the RF signal processing sub-device (301 and 302) in order and at timing supplied from the first device (400).

In still another more concrete embodiment of the invention, setting bit information (REG_AD) that sets the set operation of the time slot in either one of the first operation mode (FOPMOD) and the second operation mode (SOPMOD) is contained in the control information to execute the instruction.

In the most concrete embodiment of the invention, the setting bit information is address information (REG_AD) specifying plural registers forming the memory that stores the instruction code and the control information to execute the instruction.

The advantage achieved by the invention described above by way of representative embodiments is as follows.

That is, it is possible to enhance the degree of freedom in the operation setting of a time slot in a mobile communication terminal capable of making communications with the base station by a communication method employing the time-division multiple access method.

The above and other objects and novel features of the invention will become obvious from the following description with reference to the accompanying drawings.

### BRIEF DESCRIPTION OF THE DRAWINGS

FIG. 1 is a view showing the overall configuration of a mobile communication terminal according to one embodiment of the invention;

FIG. 2 is a view showing that a baseband signal processing LSI is connected to a first outside memory and an application processor via a first outside bus according to one embodiment of the invention shown in FIG. 1;

FIG. 3 is a state transition diagram showing plural operations that can be set in one time slot of an RF signal processing integrated circuit by a communication method employing the time-division multiple access method in one embodiment of the invention;

FIG. 4 is a view showing the bit configurations of plural words containing instruction codes and control information used for the time slot setting in the RF signal processing integrated circuit by a communication method employing the time-division multiple access method in one embodiment of the invention;

FIG. 5 is a view showing the configuration of registers available for various instructions used for the time slot setting in a word register file of a transmission and reception control sub-device inside the RF signal processing integrated circuit in one embodiment of the invention;

FIG. 6 is a view showing communication operations by the time slot setting using a first operation mode and a second operation mode according to a preferred embodiment of the invention;

FIG. 7 is a view showing in detail a front end module and the RF signal processing integrated circuit for which the set operation of a time slot is controlled in the first operation mode and the second operation mode according to the preferred embodiment of the invention;

FIG. 8 is a view showing communication operations by the time slot setting using the first operation mode and the second operation mode according to another embodiment of the invention; and

FIG. 9 is a view showing communication operations by the time slot setting using the first operation mode and the second operation mode according to still another embodiment of the invention.

### DESCRIPTION OF THE PREFERRED EMBODIMENTS

(Overall Configuration of Mobile Communication Terminal)

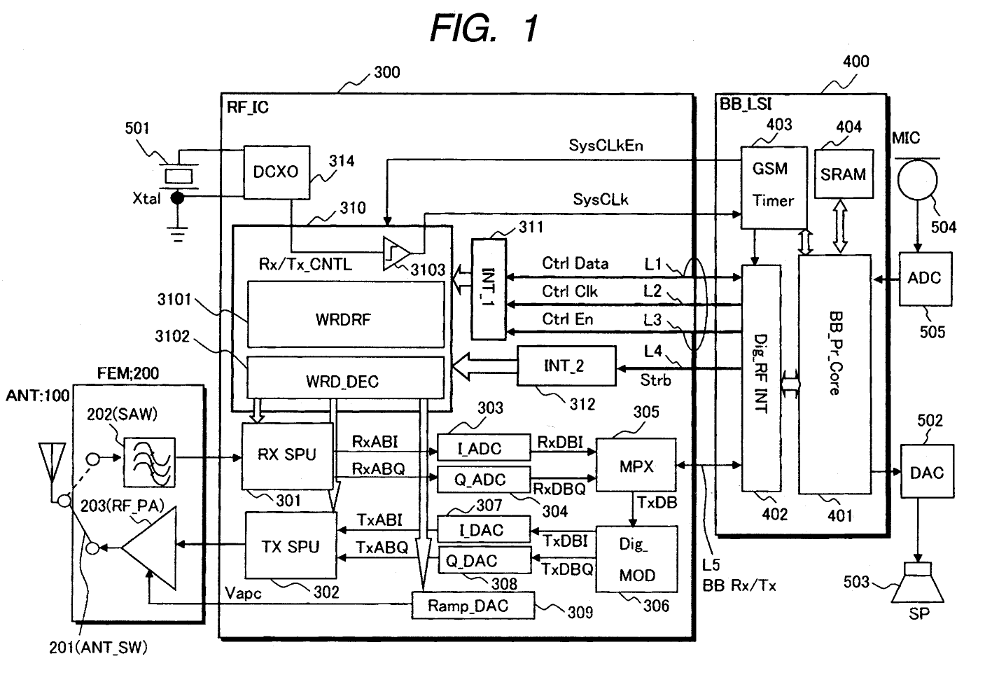

FIG. 1 is a view showing the overall configuration of a mobile communication terminal according to one embodiment of the invention. Herein, the mobile communication terminal is a mobile phone terminal; however, it may be a mobile communication device for a notebook personal computer or a PDA (Personal Digital Assist) device.

An antenna 100 (ANT) receives a reception signal from the base station at a radio frequency (hereinafter, abbreviated as RF) and outputs an RF transmission signal to the base station for the mobile phone terminal to perform a reception operation from the base station and a transmission operation to the base station. The antenna 100 is connected to a front end module 200 (FEM). The front end module 200 has an antenna switch 201 (ANT_SW) When the antenna switch 201 is connected to the upper side, an RF reception signal received at the antenna 100 is supplied to a reception filter 202 (SAW) comprising, for example, a surface acoustic wave device (it allows a desired frequency signal to pass and attenuates an interfering frequency signal). On the other hand, when the antenna switch 201 is connected to the lower side, the antenna switch 201 is connected to an output of a transmission RF power amplifier 203 (RF_PA). An RF transmission signal is therefore outputted from the antenna 100 to the base station through an RF power output of the transmission RF power amplifier 203. The antenna switch 201 of the front end module 200 is connected to the upper side during a time slot set in a reception operation in the TDMA method and to the lower side during a time slot set in a transmission operation.

An RF reception signal as an output from the reception filter 202 of the front end module 200 is connected to an input of an RF reception signal-signal processing sub-device 301 (RX_SPU) inside an RF signal processing integrated circuit 300 (RF_IC) serving as an RF signal processing device. Meanwhile, an RF input of the transmission RF power amplifier 203 of the front end module 200 is connected to an output of an RF transmission signal-signal processing sub-device 302 (TX SPU) inside the RF signal processing integrated circuit 300.

The RF signal processing integrated circuit 300 will now be described in detail.

The RF reception signal-signal processing sub-device 301 inside the RF signal processing integrated circuit 300 forms orthogonal components of an analog baseband reception signal, RxABI and RxABQ, from an RF reception signal of the reception filter 202. These orthogonal components RxABI and RxABQ are supplied, respectively, to inputs of an A-to-D converter 303 (I_ADC) for an analog baseband reception signal I and an A-to-D converter 304 (Q_ADC) for an analog baseband reception signal Q. The A-to-D converters 303 and 304 for the analog baseband reception signals I and Q convert the supplied analog baseband reception signals RxABI and RxABQ to digital baseband reception signals RxDBI and RxDBQ, respectively. These digital baseband reception signals RxDBI and RxDBQ are respectively supplied to two inputs of a multiplexer 305 (MPX). The multiplexer 305 is connected to a baseband signal processing LSI 400 (BB_LSI) serving as a baseband digital signal processing device via a two-way digital signal path L5. In a more concrete embodiment, because the two-way digital signal path L5 is a single (1-bit) signal line, two digital baseband reception signals RxDBI and RxDBQ are supplied to the baseband signal processing LSI 400 through time division in a reception operation.

In a transmission operation, the multiplexer 305 outputs a digital baseband transmission signal TxDB applied from the baseband signal processing LSI 400 via the two-way digital signal path L5 comprising a single (1-bit) signal line to a digital baseband modulator 306 (Dig_MOD). The digital baseband modulator 306 forms orthogonal components of a digital baseband transmission signal, TxDBI and TxDBQ, from the digital baseband transmission signal TxDB supplied from the multiplexer 305. These orthogonal components TxDBI and TxDBQ are supplied, respectively, to inputs of a D-to-A converter 307 (I_DAC) for a digital baseband transmission signal I and a D-to-A converter 308 (Q_DAC) for a digital baseband transmission signal Q. The D-to-A converters 307 and 308 for digital baseband transmission signals I and Q convert the supplied digital baseband transmission signals TxDBI and TxDBQ to analog baseband transmission signals TxABI and TxABQ, respectively. These signals TxABI and TxABQ are supplied to the input of the RF transmission signal-signal processing sub-device 302 (TX SPU) inside the RF signal processing integrated circuit 300. The RF transmission signal-signal processing sub-device 302 forms an RF transmission signal from the analog baseband transmission signals TxABI and TxABQ, and supplies the resulting signal to the RF power input of the transmission RF power amplifier 203. The transmission RF power amplifier 203 generates an RF power output out of an RF amplified output signal by amplifying an RF power input. The amplification gain of the transmission RF power amplifier 203 is set by an automatic power control voltage Vapc of a ramp signal D-to-A converter 309 (Ramp DAC) inside the RF signal processing integrated circuit 300.

Not only the operation condition of the ramp signal D-to-A converter 309, but also the operation conditions of the RF reception signal-signal processing sub-device 301 and the RF transmission signal-signal processing sub-device 302 are controlled in the same manner by a transmission and reception control sub-device 310 (Rx/Tx_CTRL) inside the RF signal processing integrated circuit 300. The transmission and reception control sub-device 310 is connected to the baseband signal processing LSI 400 via a first interface 311 (INT_1), a second interface 312 (INT_2), and digital signal paths L1, L2, L3, and L4. Information used in a first operation mode FOPMOD and information used in a second operation mode SOPMOD are supplied to the first interface 311 and second interface 312 from the baseband signal processing LSI 400 via the digital signal paths L1, L2, L3, and L4. For the information used in the first operation mode FOPMOD, one time slot is used as one setting unit when setting the operation conditions of the transmission and reception operations at the internal circuit of the RF signal processing integrated circuit 300 and the transmission and reception operations at the front end module 200 in order to perform the operation setting of a time slot in the time-division multiple access method. For the information used in the second operation mode SOPMOD, plural time slots are used as one setting unit when setting the operation conditions of the transmission and reception operations at the internal circuit of the RF signal processing integrated circuit 300 and the transmission and reception operations at the front end module 200 in order to perform the operation setting of a time slot in the time-division multiple access method. To be more specific, the first interface 311 receives transfer information from the digital signal paths L1, L2, and L3 in both the first operation mode FOPMOD and the second operation mode SOPMOD, whereas the second interface 312 receives the transfer information from the digital signal path L4 only in the second operation mode SOPMOD.

The digital signal in the digital signal path L1 is control data (Ctrl Data) supplied from the baseband signal processing LSI 400, and this control data contains an instruction code and control information to execute the instruction for a set operation. The digital signal in the digital signal path L2 is a control clock (Ctrl CLk) supplied from the baseband signal processing LSI 400, and this control clock is a synchronous control signal for the set operation. The digital signal in the digital signal path L3 is a control enable signal (Ctrl En) supplied from the baseband signal processing LSI 400. This control enable signal (Ctrl En) is driven at the level at which control by the baseband signal processing LSI 400 is enabled when the baseband signal processing LSI 400 sets the operation conditions of the transmission and reception operations at the internal circuit of the RF signal processing integrated circuit 300 and the transmission and reception operations at the front end module 200. Meanwhile, the digital signal in the digital signal path L4 is a strobe signal (Strb) used in the second operation mode SOPMOD. In the second operation mode SOPMOD, the operation setting using plural time slots as one setting unit is booked before this strobe signal (Strb) is outputted to the digital signal path L4. After the booking of the operation setting is completed, the strobe signal (Strb) determines at which timing in the time slot the instruction code and the control information to execute the instruction for which the operation setting has been booked are supplied to the RF signal processing sub-devices 301 and 302 and the front end module 200 from the transmission and reception control sub-device 310.

The RF signal processing integrated circuit 300 has a system reference clock oscillator 314 (DCXO). The oscillation frequency of a system reference clock signal SysCLk according to an output of the system reference clock oscillator 314 is safely maintained by a crystal resonator 501 (Xtal) provided outside of the integrated circuit 300.

The transmission and reception operations of the mobile communication terminal will now be described. The baseband signal processing LSI 400 establishes communications of the GSM method or the EDGE method using the RF signal processing integrated circuit 300 and the front end module 200. In this instance, a GSM timer 403 (GSM Timer) inside the baseband signal processing LSI 400 supplies a system reference clock signal enable SysCLkEn to the RF signal processing integrated circuit 300. The system reference clock signal SysCLk according to an output of the system reference clock oscillator 314 in the RF signal processing integrated circuit 300 is then supplied to the GSM timer 403 (GSM Timer) inside the baseband signal processing LSI 400 via a waveform shaping circuit 3103 in the transmission and reception control sub-device 310. This information is also supplied to a baseband processor core 401 (BB_Pr_Core) inside the baseband signal processing LSI 400. A CPU inside the baseband processor core 401 then starts the operation setting of a time slot in the time-division multiple access method in either the first operation mode FOPMOD or the second operation mode SOPMOD via an RF digital interface 402 (Dig_RF_INT) and the digital signal paths L1, L2, L3, and L4. A digital signal processor (DSP) inside the baseband processor core 401 executes signal processing on a reception baseband signal having undergone the processing in the RF reception signal-signal processing sub-device 301 inside the RF signal processing integrated circuit 300. In a case where the communications established beforehand are of the GSM method, phase demodulation is executed by generating a phase modulated component through this signal processing. As a result of this phase demodulation, an audio signal of a conversation with a communication party on the other end is obtained by a D-to-A converter 502 (DAC) and a speaker 503 (SP) provided outside of the baseband signal processing LSI 400. Meanwhile, an analog audio signal of a sound uttered from the user using the mobile communication terminal of FIG. 1 is converted to a digital audio signal by a microphone 504 (MIC) and an A-to-D converter 505 (ADC). The digital signal processor (DSP) inside the baseband processor core 401 executes signal processing on this digital audio signal. In a case where the communications established beforehand are of the GSM method, phase demodulation is executed by this signal processing. It is thus possible to allow the phase modulated component to be contained in a transmission baseband signal that needs to be processed in the RF transmission signal-signal processing sub-device 302 inside the RF signal processing integrated circuit 300. In a case where the communications established beforehand are of the EDGE method, not only the phase modulated component, but also the amplitude modulated component is contained in the transmission and reception information of communications. The data transfer rate of communications can be therefore improved.

It should be noted that the baseband signal processing LSI 400 has an SRAM 404 as an internal memory, which can be used as a work memory during communications of the GSM method and the EDGE method.

The operation setting of a time slot in the time-division multiple access method will now be described.

Initially, a consideration is given to a case where the operation setting is executed in the first operation mode FOPMOD in which the operation setting is executed using one time slot as one setting unit. In this case, the transmission and reception control sub-device 310 in the RF signal processing integrated circuit 300 executes operations as follows. That is, the instruction code and the control information to execute the instruction for the set operation, which are supplied as the control data (Ctrl Data) from the RF digital interface 402 in the baseband signal processing LSI 400 via the digital signal line L1, are immediately supplied to a word decoder 3102 (WRD_DEC) formed as an instruction decoder. Consequently, in a case where the set operation of a time slot is in the first operation mode FOPMOD, the transmission and reception operations of the RF signal processing sub-devices 301 and 302 and the front end module 200 are set immediately according to the instruction code and the control information to execute the instruction for the set operation in the form of the control data (Ctrl Data) from the digital signal path L1.

A consideration is next given to a case where the operation setting is executed in the second operation mode SOPMOD in which the operation setting is executed using plural time slots as one setting unit. In this case, the transmission and reception control sub-device 310 in the RF signal processing integrated circuit 300 executes operations as follows. That is, the instruction code and the control information to execute the instruction for the set operation, which are supplied as the control data (Ctrl Data) from the RF digital interface 402 in the baseband signal processing LSI 400 via the digital signal line L1, are supplied to a word register file 3101 (WRDRF) formed as an internal buffer memory. In this manner, the booking of the operation setting using plural time slots as one setting unit in the second operation mode SOPMOD is completed in the word register file 3101 (WRDRF) serving as an internal buffer memory of the transmission and reception control sub-device 310. Thereafter, to the second interface 312 is supplied the strobe signal Strb that determines at which timing in the time slot the instruction code and the control information to execute the instruction, for which the operation setting has been booked, are supplied to the RF signal processing sub-devices 301 and 302 and the front end module 200 from the transmission and reception control sub-device 310. In other words, the strobe signal Strb having a specific signal level is supplied to the second interface 312 in the RF signal processing integrated circuit 300 from the RF digital interface 402 in the baseband signal processing LSI 400 via the digital signal path L4.

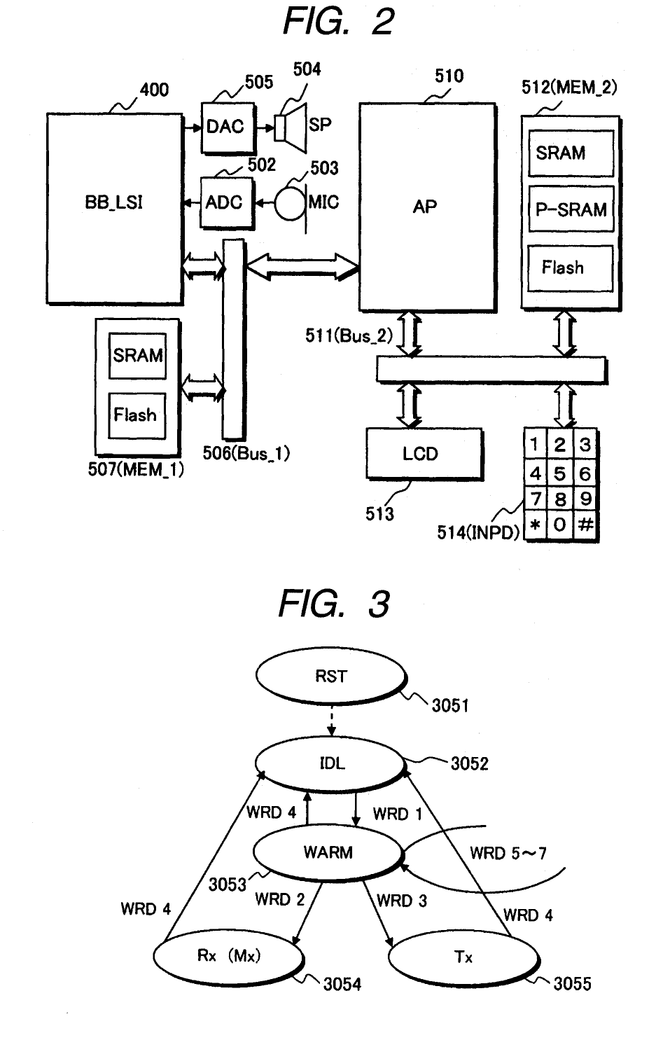

It should be noted that, as is shown in FIG. 2, the baseband signal processing LSI 400 can be connected to both a first outside memory 507 (MEM_1) and an application processor 510 (AP) via a first outside bus 506 (Bus_1). The first outside memory 507 (MEM_1) includes an SRAM used as a work memory for the baseband signal processing LSI 400 and a non-volatile memory Flash to store an operation program for the baseband signal processing LSI 400. The operation program stored in the non-volatile memory Flash includes a program for phase demodulation of a reception baseband signal and phase modulation of a transmission baseband signal of the GSM method by the digital signal processor (DSP) inside the baseband processor core 401. Also, the non-volatile memory Flash stores a program for phase demodulation and amplitude demodulation of a reception baseband signal and phase modulation and amplitude modulation of a transmission baseband signal of the EDGE method. In the preferred embodiment of the invention, the non-volatile memory Flash in the first outside memory 507 (MEM_1) stores a control program for the operation setting of a time slot to set the operation setting of a time slot in the time-division multiplex access method to either one of first operation mode FOPMOD and the second operation mode SOPMOD.

The application processor 510 (AP) connected to the baseband signal processing LSI 400 via the first outside bus 506 is connected to a second outside memory 512 (MEM_2), a liquid crystal display device 513 (LCD), and an operation key input device 514 (INPD) via a second outside bus 511 (Bus_2). The second outside memory 512 (MEM_2) includes an SRAM used as a work memory of the application processor 510, a pseudo SRAM (P—SRAM), and a non-volatile memory Flash to store an operation program for the application processor 510. In the preferred embodiment of the invention, the non-volatile memory Flash in the second outside memory 512 (MEM_2) stores a boot program (initializing processing at the time of power-on or resetting of the mobile communication terminal) and an operating system program (OS) of the mobile communication terminal. Further, the non-volatile memory Flash in the second outside memory 512 can store an execution program in a general programming language, JAVA®, various application programs, such as games, and so forth. The operation setting of a time slot to set the operation setting of a time slot in the time-division multiplex access method to either the first operation mode FOPMOD or the second operation mode SOPMOD can be executed by the boot program or the OS of the mobile communication terminal.

The baseband signal processing LSI 400 and the application processor 510 comprise different semiconductor chips. However, in another embodiment, they comprise an integrated one chip in which the application processor 510 is integrated into the semiconductor chip forming the baseband signal processing LSI 400. In still another embodiment, the RF signal processing device 300 is further integrated into the integrated one chip in which both the baseband signal processing LSI 400 and the application processing 510 are integrated. In these embodiments, it is also possible to enhance the degree of freedom in the operation setting of a time slot by a communication method employing the time-division multiple access method from the baseband signal processing LSI 400 to the RF signal processing device 300, both of which are formed in the integrated one chip. During the operation setting of a time slot by a communication method employing the time-division multiplex access method from the baseband signal processing LSI 400 to the RF signal processing device 300 within the integrated one chip, it is possible to reduce a load when information data for the operation setting is transferred within the integrated one chip via the internal bus.

(Operation of Time Slot)

FIG. 3 is a state transition diagram showing plural operations that can be set in one time slot of the RF signal processing integrated circuit 300 by a communication method employing the time-division multiple access method according to one embodiment of the invention.

As is shown in the drawing, the operational state of the RF signal processing integrated circuit 300 starts with a reset state 3051 (RST) at the time of power-on or resetting by hardware or software of the mobile communication terminal.

When the initializing processing (initialization processing) taking place at the time of the power-on or the resetting ends, the operational state of the RF signal processing integrated circuit 300 automatically undergoes a transition to an idle state 3052 (IDL). In the idle state 3052, bias currents of plural analog circuits in the RF signal processing integrated circuit 300 are set to be minute electric currents and a control clock signal to plural logic circuits is also at rest. The RF signal processing integrated circuit 300 as a whole is therefore in a stand-by state consuming extremely small and low power. A transition of the operational state of the RF signal processing integrated circuit 300 to the idle state 3052 (IDL) does not take place only automatically after this initialization processing ends. More specifically, as will be described below, a transition to the idle state 3052 is possible upon receipt of a word WRD 4 at the RF signal processing integrated circuit 300 in a state where an actual reception operation has ended in a reception state 3054 (Rx) or an actual transmission operation has ended in a transmission state 3055 (Tx). In other words, the operational state of the RF signal processing integrated circuit 300 also undergoes a transition to the idle state 3052 upon receipt of the instruction code in the word WRD 4, which is a transition instruction to the idle state from the baseband signal processing LSI 400. Also, the operational state of the RF signal processing integrated circuit 300 undergoes a transition to the idle state 3052 upon receipt of the instruction code in the word WRD 4, which is a transition instruction to the idle state from the baseband signal processing LSI 400, at the RF signal processing integrated circuit 300 in a warm-up state 3053 described below. The idle state 3052 is therefore one of the operational states that can be set in one time slot by the control instruction from the baseband signal processing LSI 400.

The operational state of the RF signal processing integrated circuit 300 undergoes a transition from the idle state 3052 to the warm-up state 3053 (WARM) upon receipt of the instruction code in a word WRD 1, which is a transition instruction to the warm-up state from the baseband signal processing LSI 400, at the RF signal processing integrated circuit 300 in the idle state 3052. The warm-up state 3053 is a preparatory period for the following reception state 3054 (Rx) or transmission state 3055 (Tx). That is to say, the RF signal processing integrated circuit 300 prepares for operations of a PLL frequency synthesizer for the following reception operation or transmission operation with the use of this warm-up state 3053. As will be described below, the PLL frequency synthesizer has a PLL (Phase Locked Loop) circuit. The PLL circuit determines the frequency of a reception carrier signal used in a reception mixer and the frequency of a transmission carrier signal used in a transmission mixer in reference to the stably maintained frequency of the system reference clock signal SysCLk generated from an output of the system reference clock oscillator 314. Because the PLL circuit includes a delay circuit element, it needs a response time that cannot be ignored to stabilize operations as per the set operation condition after the operation condition is set. This is the reason why the warm-up state 3053 is provided. The warm-up state 3053 is therefore another one of the operational states that can be set in one time slot by the control instruction from the baseband signal processing LSI 400.

In a case where the RF signal processing integrated circuit 300 receives the instruction code in a word WRD 2 from the baseband signal processing LSI 400 after it has gone through the warm-up state 3053, which is the preparation period for the transmission state or the reception state, the operational state of the RF signal processing integrated circuit 300 undergoes a transition from the warm-up state 3053 to the reception state 3054. In a case where the RF signal processing integrated circuit 300 receives the instruction code in a word WRD 3 from the baseband signal processing LSI 400, the operational state of the RF signal processing integrated circuit 300 undergoes a transition from the warm-up state 3053 to the transmission state 3055.

There are two kinds of state in the reception state 3054.

One state is a real reception state. In this state, the RF reception signal-signal processing sub-device 301 in the RF signal processing integrated circuit 300 forms digital baseband reception signals RxDBI and RxDBQ according to a reception radio wave from the base station, and transfers these signals to the baseband signal processing LSI 400 via the multiplexer 305 and the two-way digital signal path L5.

The other state is a virtual reception state. In this state, none of the digital baseband reception signals RxDBI and RxDBQ is transferred from the RF reception signal-signal processing sub-device 301 in the RF signal processing integrated circuit 300 to the baseband signal processing LSI 400 via the multiplexer 305 and the two-way digital signal path L5. This virtual reception signal is referred to as the monitor state (Mx) in the embodiment of the invention. In the monitor state, a kind of reception operation different from the one in the real reception state is executed, and for example, the RF reception signal-signal processing sub-device 301 in the RF signal processing integrated circuit 300 detects the field intensity of a radio wave transmitted from the base station and received at the mobile phone terminal. It should be noted that a transition to the monitor state (Mx), which is one state of the reception state 3054, is also allowed to take place upon receipt of the instruction code in a word WRD 2.

Referring to the state transition diagram shown in FIG. 3, the instruction codes in the words WRD 5 through 7 are used for the initial setting, such as the configuration. The instruction codes in these words WRD 5 through 7 can be used only in the first operation mode FOPMOD in which the setting operation of a time slot is executed using one time slot as one setting unit. When the initial setting by the instruction codes in the words WRD 5 through 7 ends, the operational state automatically returns to the warm-up state 3053 (WARM).

Incidentally, in this embodiment of the invention, in a case where the reception operations 3054 (Rx) are executed continuously in plural time slots, such an execution is enabled by continuously receiving the instruction codes in plural words WRD 2. Likewise, in a case where the transmission states 3055 (Tx) are executed continuously in plural time slots, such an execution is enabled by continuously receiving the instruction codes in plural words WRD 3. It should be noted that a direct transition between the reception state 3054 and the transmission state 3055 is not allowed. In other words, for a transition to take place between these two states, it is necessary to receive the instruction code in the word WRD 4, which is a transition instruction to the idle state 3052 (IDL) and to receive the instruction code in the word WRD 1, which is a transition instruction to the warm-up state 3053 (WARM). As has been described, for a transition to take place between the reception operation 3054 (Rx) and the transmission operation 3055 (Tx), two words, WRD 4 and WRD 1, are required, which are two well-defined instructions from the baseband signal processing LSI 400.

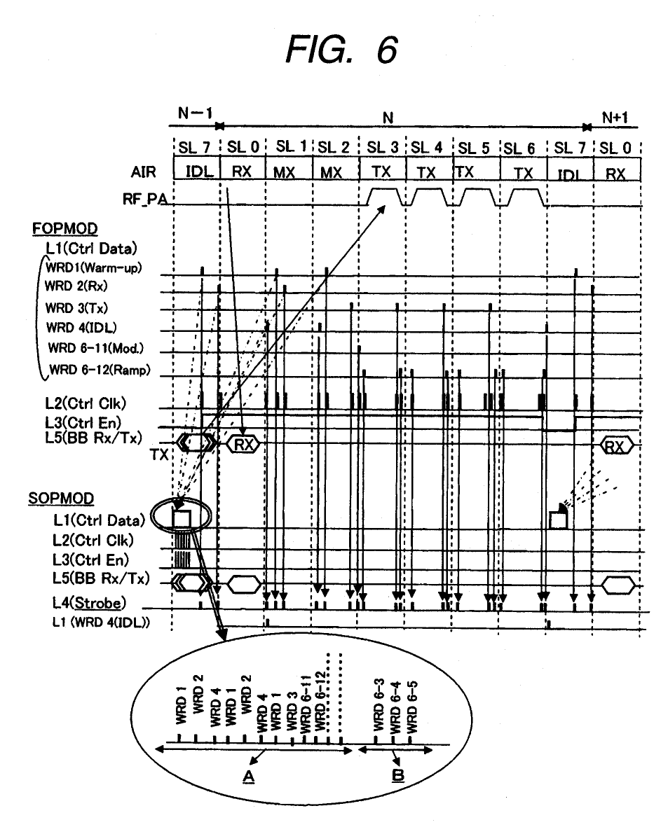

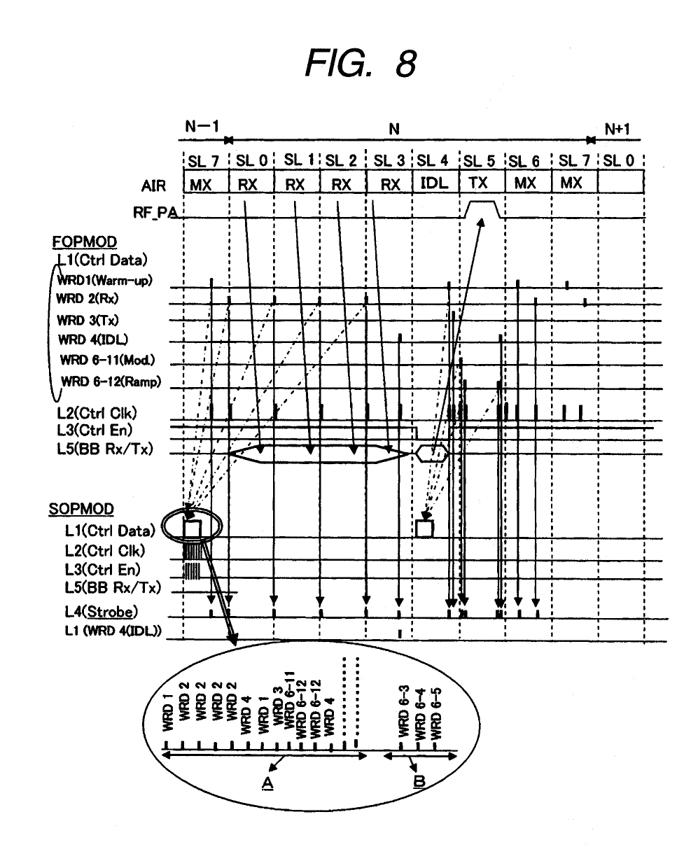

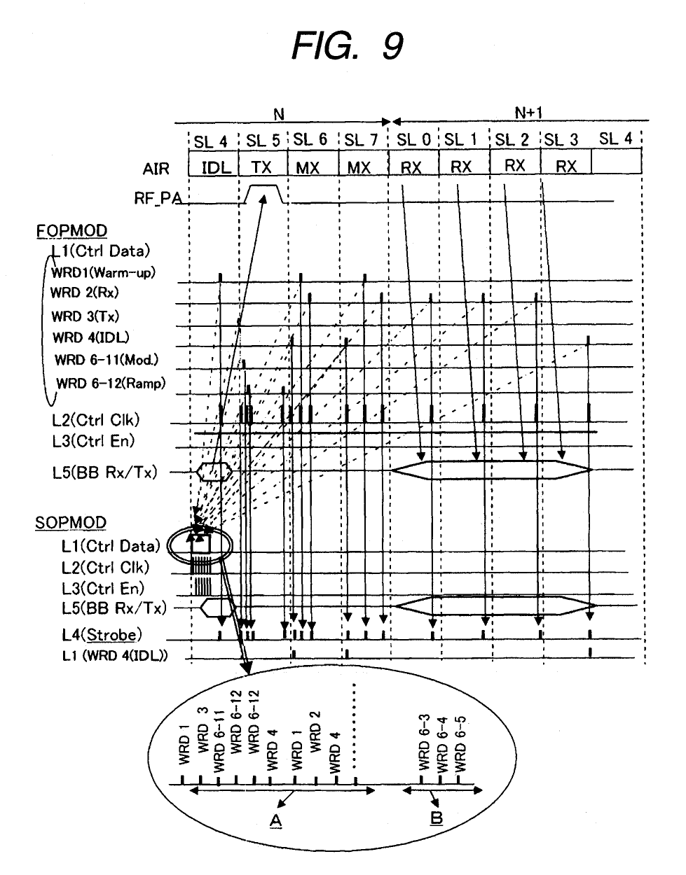

Further, the warm-up state 3053 (WARM) is not set as one set operation over the entire period of one time slot. Attention should be paid to the fact that the warm-up state 3053 (WARM) is a temporary transition state taking place upon receipt of the word WRD 1, which is a transition instruction to the warm-up state 3053 in one time slot being set in the idle state 3052 (IDL) or the monitor state (Mx). By subsequently receiving the instruction code in the word WRD 2, which is a transition instruction to the reception state 3054 (Rx), or the instruction code in the word WRD 3, which is a transition instruction to the transmission state 3055 (Tx) the operational state of the immediately following time slot is set to either the transmission operation or the reception operation. This will become obvious from communication operations by the set operation of a time slot described below with reference to FIG. 6, FIG. 8, and FIG. 9.

(Instruction Code and Control Information for Time Slot Setting and Instruction Register)

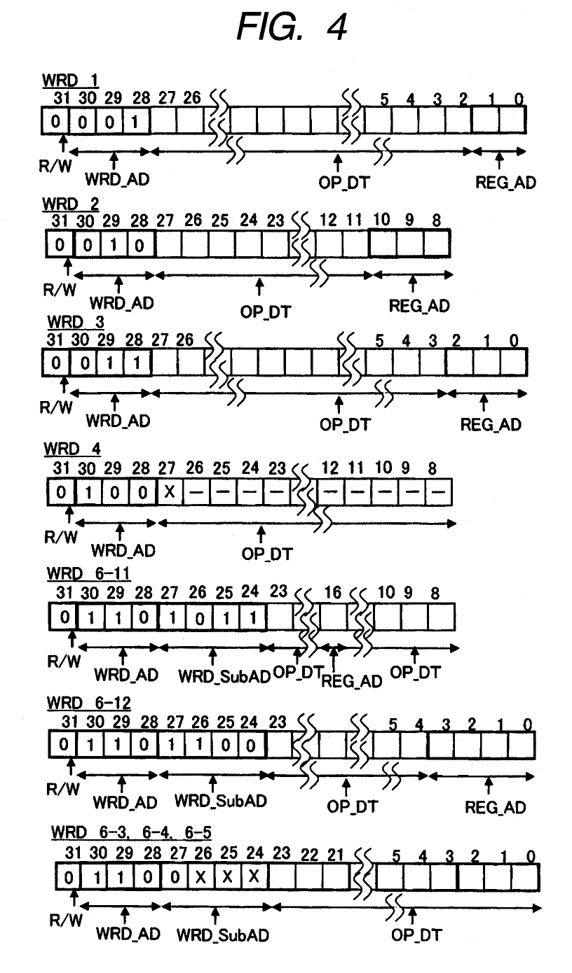

FIG. 4 is a view showing the bit configurations of plural words each containing the instruction code and the control information used for the time slot setting in the RF signal processing integrated circuit 300 by a communication method employing the time-division multiple access method in one embodiment of the invention.

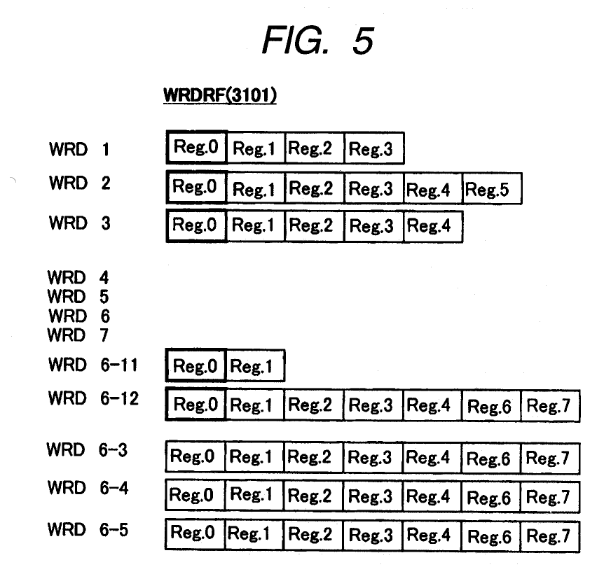

The portion of the word WRD 1 in the drawing indicates that the word WRD 1, which is a transition instruction from the idle state 3052 to the warm-up state 3053, has a 32-bit length comprising the bit 31 through the bit 0. The R/W (read/write) bit at the bit 31, which is the most significant bit, exhibits “0” (W (write)), thereby being identified as an instruction to be written into the RF signal processing integrated circuit 300 from the baseband signal processing LSI 400. A bit string, “001”, comprising three bits from the bit 30 to the bit 28 on the higher order bit side is a word address WRD_AD that identifies this instruction as the word WRD 1. This word address WRD_AD can be compared to the operation code in an instruction in the case of a micro-processor. The lower two bits (bit 1 and bit 0) including the least significant bit is an address REG_AD of four registers Reg. 0 through Reg. 3 of a 32-bit length available for the instruction specified by the word WRD 1 in the word register file 3101 (WRDRF) in the transmission and reception control sub-device 310 inside the RF signal processing integrated circuit 300. The four registers Reg. 0 through Reg. 3 of a 32-bit length available for the instruction specified by the word WRD 1 are indicated in the portion of the word WRD 1 in FIG. 5. The first register Reg. 0 is used only in the first operation mode FOPMOD in which the setting operation of a time slot is executed using one time slot as one setting unit. The second through fourth registers Reg. 1 through Reg. 3 are used only in the second operation mode SOPMOD in which the setting operation of a time slot is executed using plural time slots as one setting unit. The second through fourth registers Reg. 1 through Reg. 3 can be used to store the word WRD 1, which is a transition instruction to the warm-up state in the time slots respectively determined in the first, second, and third times in the second operation mode SOPMOD. As has been described, the address REG_AD of the registers comprising the lower two bits including the least significant bit designates the registers used by the word WRD 1. In addition, attention should be paid to the fact that the address REG_AD of the registers is also the setting bit information indicating whether the word WRD 1 executes the setting operation of a time slot in the first operation mode (FOPMOD) or in the second operation mode (SOPMOD).

In the portion of the word WRD 1 in FIG. 4, a bit string comprising two bits at the bit 27 and the bit 26 on the higher order bit side indicates any one frequency band from multiple frequency bands, herein, four frequency bands including GSM 850 MHz, GSM 900 MHz, DCS 1800 MHz, and PCS 1900 MHz. As has been described, the bit 27 on the higher order bit side through the bit 2 in a lower order bit side contain various kinds of control information needed to prepare the operations of the PLL frequency synthesizer for the following reception operation or transmission operation. Herein, DCS is an abbreviation of the digital cellular system, and PCS is an abbreviation of the personal communication system.

The portion of the word WRD 2 in FIG. 4 indicates that the word WRD 2, which is a transition instruction from the warm-up state 3053 to the reception state 3054 (Rx), has a 24-bit length comprising the bit 31 through the bit 8. The R/W (read/write) bit at the bit 31, which is the most significant bit, exhibits “0” (W (write)), thereby being identified as an instruction to be written into the RF signal processing integrated circuit 300 from the baseband signal processing LSI 400. A bit string, “010”, comprising three bits from the bit 30 to the bit 28 on the higher order bit side is a word address WRD_AD that identifies this instruction as the word WRD 2. The lower three bits (bit 10, bit 9, and bit 8) are addresses of six registers Reg. 0 through Reg. 5 of a 24-bit length available for the instruction specified by the word WRD 1 in the word resister file 3101 (WRDRF) in the transmission and reception control sub-device 310 inside the RF signal processing integrated circuit 300. The six registers Reg. 0 through Reg. 5 of a 24-bit length available for the instruction specified by the word WRD 2 are indicated in the portion of the word WRD 2 in FIG. 5. The first register Reg. 0 is used only in the first operation mode FOPMOD in which the setting operation of a time slot is executed using one time slot as one setting unit. The second through sixth registers Reg. 1 through Reg. 5 are used only in the second operation mode SOPMOD in which the setting operation of a time slot is executed using plural time slots as one setting unit. The second through sixth registers Reg. 1 through Reg. 5 can be used to store the word WRD 2, which is a transition instruction to the reception state in the time slots respectively determined in the first, second, third, fourth, and fifth times in the second operation modes SOPMOD. As has been described the address REG_AD of the registers comprising lower three bits designates the registers used by the word WRD 2. In addition, attention should be paid to the fact that the address REG_AD of the registers is also the setting bit information to specify whether the word WRD 2 executes the setting operation of a time slot in the first operation mode (FOPMOD) or in the second operation mode (SOPMOD).

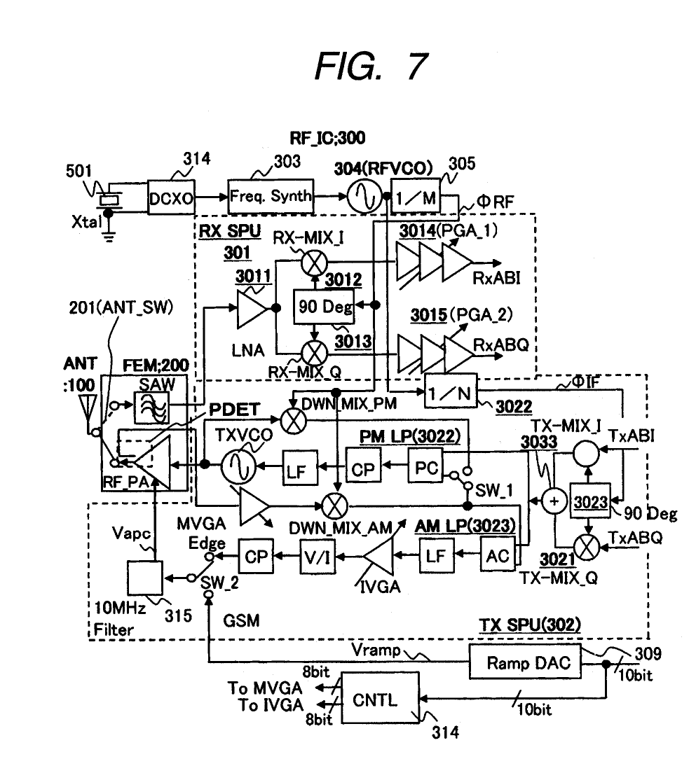

In the portion of the word WRD 2 in FIG. 4, a bit string comprising 18 bits from the bit 27 to the bit 11 on the higher order bit side determines various conditions of a reception operation of the RF reception signal-signal processing sub-device 301 inside the RF signal processing integrated circuit 300. For example, the gain or the frequency band of variable gain amplifiers 3014 and 3015 inside the RF reception signal-signal processing sub-device 301 described below with reference to FIG. 7 is determined by the bit string comprising the 18 bits specified above.

The portion of the word WRD 3 in FIG. 4 indicates that the word WRD 3, which is a transition instruction from the warm-up state 3053 to the transmission state 3055 (Tx), has a 32-bit length comprising the bit 31 through the bit 0. The R/W (read/write) bit at the bit 31, which is the most significant bit, exhibits “0” (W (write)), thereby being identified as an instruction to be written into the RF signal processing integrated circuit 300 from the baseband signal processing LSI 400. A bit string, “011”, comprising three bits from the bit 30 to the bit 28 on the higher order bit side is a word address WRD_AD that identifies this instruction as the word WRD 3. The lower three bits (bit 2, bit 1, and bit 0) including the least significant bit are addresses of five registers Reg. 0 through Reg. 4 of a 32-bit length available for the instruction specified by the word WRD 3 in the word resister file 3101 (WRDRF) in the transmission and reception control sub-device 310 inside the RF signal processing integrated circuit 300. The five registers Reg. 0 through Reg. 4 of a 32-bit length available for the instruction specified by the word WRD 3 are indicated in the portion of the word WRD 3 in FIG. 5. The first register Reg. 0 is used only in the first operation mode FOPMOD in which the setting operation of a time slot is executed using one time slot as one setting unit. The second through fifth registers Reg. 1 through Reg. 4 are used only in the second operation mode SOPMOD in which the setting operation of a time slot is executed using plural time slots as one setting unit. The second through fifth registers Reg. 1 through Reg. 4 can be used to store the word WRD 3, which is a transition instruction to the transmission state, in the time slots respectively determined in the first, second, third, and fourth times in the second operation mode SOPMOD. As has been described, the address REG_AD of the registers comprising the lower three bits including the least significant bit designates the registers used by the word WRD 3. In addition, attention should be paid to the fact that the address REG_AD of the registers is also the setting bit information specifying whether the word WRD 3 executes the setting operation of a time slot in the first operation mode (FOPMOD) or in the second operation mode (SOPMOD).

In the portion of the word WRD 3 in FIG. 4, a bit string comprising 25 bits from the bit 27 on the higher order side to the bit 3 on the lower bit side determines various conditions of the transmission operation of the RF transmission signal-signal processing sub-device 302 inside the RF signal processing integrated circuit 300 and the transmission RF power amplifier 203. For example, this bit string is used to control a phase control loop 3022 (PM_LP) for phase modulation in communications of the GSM method and the EDGE method and to control an amplitude control loop 3023 (AM_LP) for amplitude modulation in communications of the EDGE method, both of which will be described below with reference to FIG. 7 and provided inside the RF transmission signal-signal processing sub-device 302. Further, this bit string is used to control the level of maximum transmission power at a constant level between the ramp-up and the ramp-down of transmission power of the transmission RF power amplifier 203.

The portion of the word WRD 4 in FIG. 4 indicates that the word WRD 4, which is a transition instruction to the idle state 3052 (IDL), has a 4-bit length comprising the bit 31 through the bit 28. The R/W (read/write) bit at the bit 31, which is the most significant bit, exhibits “0” (W(write)), thereby being identified as an instruction to be written into the RF signal processing integrated circuit 300 from the baseband signal processing LSI 400. A bit string, “100”, comprising three bits from the bit 30 to the bit 28 on the higher bit side is an address WRD_AD that identifies this instruction as the word WRD 4. When the bit 27 on the higher bit side exhibits “1”, it specifies a transition to the idle state 3052 (IDL), and when the bit 27 exhibits “0”, it specifies a transition to the software reset state 3051 (RST). It should be noted that in the preferred embodiment of the invention, the word WRD 4 is not used in the second operation mode SOPMOD in which the setting operation of a time slot is executed using plural time slots as one setting unit for the operation setting of a time slot. The word WRD 4 is used only in the first operation mode FOPMOD in which the operation setting of a time slot is executed using one time slot as one setting unit. One of the reasons why is because the period of the idle state 3052 to which a transition has been made by the word WRD 4 can be utilized effectively to book the operation setting in the second operation mode SOPMOD using plural time slots as one setting unit. The other period during which the operation setting can be booked in the second operation mode SOPMOD using plural time slots as one setting unit is the monitor state (Mx), which is one state of the reception state 3054.

The word WRD 4, which is a transition instruction to the idle state, does not contain the address REG_AD of registers. Hence, attention should be paid to the fact that, as is shown in FIG. 5, no register is allocated to the word WRD 4. The transition instruction to the idle state specified by the word WRD 4 is used only in the first operation mode FOPMOD. The word WRD 4 therefore falls outside the allocation range of an instruction register in FIG. 5 provided for the second operation mode SOPMOD.

The portion of the word WRD 6-11 in FIG. 4 indicates that the word WRD 6-11, which is a modulation control instruction for a transmission (TX), has a 24-bit length comprising the bit 31 through the bit 8. The R/W (Read/Write) bit at the bit 31, which is the most significant bit, exhibits “0” (W (write)), thereby being identified as an instruction to be written into the RF signal processing integrated circuit 300 from the baseband signal processing LSI 400. A bit string, “110”, comprising three bits from the bit 30 to the bit 28 on the higher order bit side and a bit string, “1011”, comprising four bits from the bit 27 to the bit 24 are, respectively, a word address WRD_AD and a word sub-address WRD_SubAD that identifies this instruction as the word WRD 6-11. A modulation control instruction for a transmission (TX) specified by the word WRD 6-11 controls the function of forming the orthogonal components of a digital baseband transmission signal, TxDBI and TxDBQ, from a digital baseband transmission signal TxDB in the digital baseband modulator 306 (Dig_MOD) inside the RF signal processing integrated circuit 300 of FIG. 1. The word WRD 6-11 is used to adjust start timing (strobe timing) of digital modulation by the GSM method and the EDGE method. When the bit 16 in the address REG_AD exhibits “1”, it indicates that the word WRD 6-11 is used in the first operation mode FOPMOD, and when the bit 16 in the address REG_AD exhibits “0”, it indicates that the word WRD 6-11 is used in the second operation mode SOPMOD. Two registers Reg. 0 and Reg. 1 having a 24-bit length and available for the instruction specified by the word WRD 6-11 are indicated in the portion of the word WRD 6-11 in FIG. 5. The first register Reg. 0 is used only in the first operation mode FOPMOD in which the setting operation of a time slot is executed using one time slot as one setting unit. The second register Reg. 1 is used only in the second operation mode SOPMOD in which the setting operation of a time slot is executed using plural time slots as one setting unit. As has been described, attention should be paid to the fact that the bit 16 in the address REG_AD of the register is also the setting bit information specifying whether the word WRD 6-11 executes the setting operation of a time slot in the first operation mode (FOPMOD) or in the second operation mode (SOPMOD).

The portion of the word WRD 6-12 in FIG. 4 indicates that the word WRD 6-12, which is a ramp control instruction, has a 32-bit length comprising the bit 31 through the bit 0. The R/W (Read/Write) bit at the bit 31, which is the most significant bit, exhibits “0” (W (write)), thereby being identified as an instruction written into the RF signal processing integrated circuit 300 from the baseband signal processing LSI 400. A bit string, “110”, comprising three bits from the bit 30 to the bit 28 on the higher order bit side and a bit string, “1100”, comprising four bits from the bit 27 to the bit 24 are, respectively, a word address WRD_AD and a word sub-address WRD_SubAD that identifies this instruction as the word WRD 6-12. The ramp control instruction specified by the word WRD 6-12 controls the switching regarding to which of a reception (RX) and a transmission (TX) the antenna switch 202 of the front end module 200 in FIG. 1 is connected and a connection delay time, and the time mask setting between the ramp-up and the ramp-down of transmission power in the transmission RF power amplifier 203. The lower four bits (bit 3, bit 2, bit 1, and bit 0) including the LSB are the addresses of eight registers Reg. 0 through Reg. 7 of a 32-bit length available for the instruction specified by the word WRD 6-12 in the word register file 3101 (WRDRF) of the transmission and reception control sub-device 310 inside the RF signal processing integrated circuit 300. The eight registers Reg. 0 through Reg. 7 having a 32-bit length and available for the instruction specified by the word WRD 6-12 are indicated in the portion of the word WRD 6-12 in FIG. 5. The first register Reg. 0 is used only in the first operation mode FOPMOD in which the setting operation of a time slot is executed using one time slot as one setting unit. The second through eighth registers Reg. 1 through Reg. 7 are used only in the second operation mode SOPMOD in which the setting operation of a time slot is executed using plural time slots as one setting unit. The second through eighth registers Reg. 1 through Reg. 7 can be used to store the word WRD 6-12, which is a transition instruction to the transmission state, in the time slots respectively determined in the first, second, third, fourth, fifth, sixth, and seventh times in the second operation mode SOPMOD. As has been described, attention should be paid to the fact that the address REG_AD of the registers comprising the lower four bits including the least significant bit is also the setting bit information specifying whether the word WRD 6-12 executes the setting operation of a time slot in the first operation mode (FOPMOD) or in the second operation mode (SOPMOD).

The portion of the words WRD 6-3, 6-4, and 6-5 in FIG. 4 indicates that the words WRD 6-3, 6-4, and 6-5, which are event control instructions using a strobe signal (Strb) in the second operation mode SOPMOD, have a 32-bit length comprising the bit 31 through the bit 0. The R/W (Read/Write) bit at the bit 31, which is the most significant bit, exhibits “0” (W (write)), thereby being identified as an instruction written into the RF signal processing integrated circuit 300 from the baseband signal processing LSI 400. A bit string, “110”, comprising three bits from the bit 30 to the bit 28 on the higher order bit side and a bit string, “0XXX (X=“0” or X=“1”)”, comprising four bits from the bit 27 to the bit 24 are, respectively, a word address WRD_AD and a word sub-address WRD_SubAD that identifies these instructions as the words WRD 6-3, 6-4, and 6-5. In the event control instructions specified by the words WRD 6-3, 6-4, and 6-5 using a strobe signal (Strb) in the second operation mode SOPMOD, the three bits from the bit 23 to the bit 21 is the operation code information of an instruction executed in the first time in the event using the strobe signal (Strb) in the second operation mode SOPMOD. The operation code information specifies which of the NOP (No operation), the word WRD 1, the word WRD 2, the word WRD 3, the word WRD 4, the word WRD 6-11, and the word WRD 6-12 is the instruction to be executed in the first time. Likewise, the bit 20 through bit 18 in the event control instruction can specify the instruction executed in the second time in the event, . . . the bit 5 through the bit 3 can specify the instruction executed in the seventh time in the event, and the bit 2 through the bit 0 can specify the instruction executed in the eighth time in the event. The words WRD 6-3, 6-4, and 6-5, which are three instructions each having the operation code information (corresponding to eight units of 3-bit information) of a 24-bit length, can designate instructions 24 times in total. Herein, 24 registers Reg. 0 through Reg. 7, Reg. 0 through Reg. 7, and Reg. 0 through Reg. 7 having a 32-bit length and available for the instructions specified by the words WRD 6-3, 6-4, and 6-5 are indicated in the portions of the words WRD 6-3, 6-4, and 6-5 in FIG. 5.

As has been described, FIG. 5 shows the configurations of the registers available for various instructions used in the time slot setting in the word register file 3101 (WRDRF) of the transmission and reception control sub-device 310 inside the RF signal processing integrated circuit 300. Attention should be paid to the fact that, in FIG. 5, no register is allocated to the word WRD 4, which is a transition instruction to the idle state, and the words WRD 5 through 7, which are instructions used in the initialization setting, such as the configuration, both used only in the first operation mode FOPMOD for executing the setting operation of a time slot. Because these instructions are used only in the first operation mode FOPMOD, they fall outside the allocation range of the instruction register in FIG. 5 provided for the second operation mode SOPMOD.

(Communication Operations by Time Slot Setting)

FIG. 6 is a view showing communication operations by the time slot setting using the first operation mode FOPMOD and the second operation mode SOPMOD according to the preferred embodiment of the invention.

In the upper portion of FIG. 6, N−1, N, and N+1 indicate frames, and each frame comprises eight time slots SL 0 through SL 7 according to the standards of the GSM method and the EDGE method. As has been described, each time slot can be set in any one of the idle state (IDL), the reception state (RX, MX), and the transmission state (TX). In each time slot set in the transmission state (TX), the RF power output of the transmission RF power amplifier 203 in the front end module 200 shown in FIG. 1 is ramped up and ramped down.

In the center portion of FIG. 6, operations are shown in the first operation mode FOPMOD in which the operation setting of a time slot in the time-division multiple access method is executed using one time slot as one setting unit. Following are the instructions as the control data (CtrlData) supplied from the baseband signal processing LSI 400 to the first interface 311 via the digital signal path L1: instructions specified by the word WRD 1, the word WRD 2, the word WRD 3, the word WRD 4, the word 6-11, and the word WRD 6-12. The word WRD 1 is a transition instruction to the warm-up state 3053. The word WRD 2 is a transition instruction to the reception state 3054 (RX, MX). The word WRD 3 is a transition instruction to the transmission state 3055 (Tx). The word WRD 4 is a transition instruction to the idle state 3052 (IDL). The word WRD 6-11 is a modulation control instruction in a transmission (TX). The word WRD 6-12 is a ramp control instruction. Some of these instructions are supplied to the RF signal processing integrated circuit 300. Also, the control clock (CtrlCLk) and the control enable signal (Ctrl En) are supplied from the baseband signal processing LSI 400 via the digital signal paths L2 and L3, respectively. In addition, baseband transmission and reception signals (BB Rx/Tx) are delivered between the baseband signal processing LSI 400 and the RF signal processing integrated circuit 300 via the two-way digital signal path L5.

For the eighth time slot (SL 7) in the frame N−1, the operation is set to the idle state (IDL) because the idle state was designated in the previous seventh time slot (SL 6). During the eighth time slot (SL 7) set in the idle state (IDL), the baseband transmission signal (BB Tx) is transmitted from the baseband signal processing LSI 400 to the RF signal processing integrated circuit 300 via the two-way digital signal path L5 for a transmission operation (TX) in and after the following fourth time slot (SL 3) in the frame N. The transmitted baseband transmission signal (BB Tx) is stored in the SRAM (not shown in FIG. 1) inside the RF signal processing integrated circuit 300. In response to the word WRD 1 and the word WRD 2 applied in the latter half of the eighth time slot (SL 7) in the frame N−1 set in the idle state (IDL), the operation of the first time slot (SL 0) in the frame N is set to the reception state (RX). The RF signal processing integrated circuit 300 then receives an RF transmission signal from the base station, and supplies the baseband reception signal (BB Rx) to the baseband signal processing LSI 400 via the two-way digital signal path L5. In response to the word WRD 1 and the word WRD 2 applied after the word WRD 4 in the second time slot (SL 1), the operation of the second time slot (SL 1) in the frame N is set to the reception state (MX). Because this reception state (Mx) is the monitor state (Mx), which is a virtual reception state, no baseband reception signal (BB Rx) is supplied to the baseband signal processing LSI 400 via the two-way digital signal path L5 in the second time slot (SL 1). In the third time slot (SL 2) in the frame N, the word WRD 4, which is a transition instruction to the idle state, and the word WRD 1, which is a transition instruction to the warm-up state, are applied for the operation of the following fourth time slot (SL 3) to undergo a transition to the transmission state (Tx). The reason why is, as has been described, because a direct transition between the reception state and the transmission state is not allowed in the operation setting of a time slot. As the word WRD 3, which is a transition instruction to the transmission state, is applied in the latter half of the third time slot (SL 2), the operation of the fourth time slot (SL 3) is set to the transmission state (Tx). The transmission operation is executed as the word WRD 6-11, which is a modulation control instruction in a transmission (TX), and the word WRD 6-12, which is a ramp control instruction, are further applied. In the subsequent fifth time slot (SL 4), sixth time slot (SL 5), and seventh time slot (SL 6), after the transmission operation is executed three times, the operation of the eighth time slot (SL 7) undergoes a transition to the idle state (IDL) in response to the word WRD 4, which is a transition instruction to the idle state, applied in the latter half of the seventh time slot (SL 6).

In a case where the set operation of a time slot shown in the center portion of FIG. 6 is in the first operation mode FOPMOD in which the operation setting of a time slot in the TDMA method is executed using one time slot as one setting unit, the baseband signal processing LSI 400 processes a relatively heavy job in each time slot from the eight time slot (SL 7) in the frame N−1 to the seventh time slot (SL 6) in the frame N. For this job, the baseband signal processing LSI 400 needs to supply not only various instruction codes but also a large volume of various kinds of control information specified below to execute the instruction to the transmission and reception control sub-device 310 inside the RF signal processing integrated circuit 300. The first one is the control information of the gain and the frequency band of the variable gain amplifiers 3014 and 3015 inside the RF reception signal-signal processing sub-device 301 in the word WRD 2 for a reception operation. The second one is the control information of the phase control loop 3022 (PM_LP) for the phase modulation in communications by the GSM method and the EDGE method provided inside the RF signal transmission signal-signal processing sub-device 302 in the word WRD 3 for a transmission operation. In a case where communications are of the EDGE method, the second one also includes the control information to control the amplitude control loop 3023 (AM_LP) for amplitude modulation and to control the level of the maximum transmission power at the constant level between the ramp-up and the ramp-down of the transmission power of the transmission RF power amplifier 203. The third one is the control information of the start timing (strobe timing) of digital modulation by the GSM method and the EDGE method in the word WRD 6-11, which is a modulation control instruction in a transmission (TX). The fourth one is the control information for the control regarding to which of the reception (RX) and the transmission (TX) the antenna switch 202 is to be connected and the connection delay, and the time mask setting between the ramp-up and the ramp-down of the transmission power in the transmission RF power amplifier 203 in the word WRD 6-12, which is a ramp control instruction.

In the case of a reception, the baseband signal processing LSI 400 needs to execute the phase demodulation by the GSM method and the amplitude demodulation by the EDGE method by means of the digital signal processor (DSP) for the reception baseband signal in each time slot for a reception. In the case of a transmission, the baseband signal processing LSI 400 needs to execute the phase modulation by the GSM method and the amplitude modulation by the EDGE method by means of the digital signal processor (DSP) for the transmission baseband signal in each time slot for a transmission.

On the contrary, by adopting the second operation mode SOPMOD in which the operation setting of a time slot in the TDMA method is executed using plural time slots as one setting unit, it is possible to reduce the burden of a job of supplying various instruction codes and various kinds of control information to the transmission and reception control sub-device 310 inside the RF signal processing integrated circuit 300. The lower portion of FIG. 6 indicates an operation in the second operation mode SOPMOD in which the operation setting of a time slot in the time-division multiple access is executed using plural time slots as one setting unit. All the instructions, including the words WRD 1, WRD 2, WRD 4, . . . WRD 6-11, WRD 6-12, and so forth and related control information (A) indicated at the lower portion of FIG. 6, are supplied to the transmission and reception control sub-device 310 inside the RF signal processing integrated circuit 300 from the baseband signal processing LSI 400 during the eighth time slot (SL 7) in the frame N−1 set in the idle state (IDL). Immediately after this event, the words WRD 6-3, 6-4, and 6-5 (B), which specify the execution order of plural instructions, are supplied to the transmission and reception control sub-device 310 inside the RF signal processing integrated circuit 300 from the baseband signal processing LSI 400 during the eighth time slot (SL 7) in the frame N−1 set in the idle state (IDL). Because a job is light during the eighth time slot (SL 7) in the frame N−1 set in the idle state (IDL), the baseband signal processing LSI 400 is able to supply all the instructions and related control information as well as the information about the execution order of plural instructions to the RF signal processing integrated circuit 300 with relative ease. As has been described, it is possible to book all the instructions and related control information as well as the information about the execution order of plural instructions in the word register file 3101 (WRDRF) in the transmission and reception control sub-device 310 inside the RF signal processing integrated circuit 300 during the eighth slot (SL 7) in the frame N−1 set in the idle state (IDL). Thereafter, the booked instruction in each time slot can be executed by supplying a strobe signal (Strb) alone that specifies the timing at which the instructions booked in the first through eighth time slots (SL 0 through 7) in the frame N are actually executed to the transmission and reception control sub-device 310 from the baseband signal processing LSI 400 via the digital signal path L4.

(Front End Module 200 and RF Signal Processing Integrated Circuit 300 Subjected to Operation Setting)

FIG. 7 is a view showing in detail the front end module 200 and the RF signal processing integrated circuit 300 for which the setting operation of a time slot is controlled in the first operation mode FOPMOD and the second operation mode SOPMOD according to the preferred embodiment of the invention.

Referring to the drawing, a frequency synthesizer 303, to which is applied the system reference clock signal SysCLk from the system reference clock oscillator 314 (DCXO) whose oscillation frequency is maintained stably by the crystal resonator 501 (Xtal) provided outside of the integrated circuit 300, also maintains the frequency of an RF oscillator 304 (RFVCO) in a stable manner. As the RF output of the RF oscillator 304 (RFVCO) is supplied to a divider 305 (1/M), an RF signal φRF is obtained from the output of the divider 305 (1/M). The RF signal φRF is supplied to both the RF reception signal-signal processing sub-device 301 (RX SPU) and the RF transmission signal-signal processing sub-device 302 (TX SPU) inside the RF signal processing integrated circuit 300 (RF_IC).

In the time slot set in the reception state, the antenna switch 201 (ANT_SW) of the front end module 200 (FEM) is connected to the upper side. The RF reception signal received at the antenna 100 is therefore supplied to an input of a low noise amplifier 3011 (LNA) of the RF reception signal-signal processing sub-device 301 (RX SPU) via the reception filter 202 (SAW) comprising, for example, a surface acoustic wave device. An RF amplified output signal of the low noise amplifier 3011 (LNA) is supplied to one of inputs of both of two mixing circuits RX-MIX_I and RX-MIX-Q forming a reception mixer 3012. Two RF reception carrier signals formed in a 90° phase shifter 3014 (90Deg) to have a phase of 90° according to the RF signal φRF from the divider 305 (1/M) are supplied to the other inputs of the two mixing circuits RX-MIX_I and RX-MIX-Q. Consequently, direct down frequency conversion from the RF reception signal frequency to the baseband signal frequency is executed in the mixing circuits RX-MIX_I and RX-MIX-Q forming the reception mixer 3012, and the reception analog baseband signals RxABI and RxABQ are obtained from the resulting outputs. These reception analog baseband signals RxABI and RxABQ are, respectively, amplified in the variable gain amplifiers 3014 and 3015 in which the gain has been adjusted in the reception time slot setting, after which they are supplied to inputs of the A-to-D converter 303 (I_ADC) for an analog baseband reception signal I and the A-to-D converter 304 (Q_ADC) for an analog baseband reception signal Q shown in FIG. 1.

In the time slot set in the transmission state, the analog baseband transmission signals TxABI and TxABQ as the outputs from the D-to-A converter 307 (I_DAC) for a digital baseband transmission signal I and the D-to-A converter 308 (Q_DAC) for a digital baseband transmission signal Q shown in FIG. 1 are supplied, respectively, to one of inputs of both of two mixing circuits TX-MIX_I and TX-MIX_Q forming a transmission mixer 3021 shown in FIG. 7. As the RF signal φ(RF, which is an output from the divider 305 (1/M), is divided by another divider 3022 (1/N), a signal φIF at an intermediate frequency (hereinafter, abbreviated as IF) of about 80 MHz is obtained. Two IF transmission carrier signals formed in a 90° phase shifter 3023 (90Deg) to have a phase of 90° according to the IF signal φIF are supplied to the other inputs of the two mixing circuits TX-MIX_1 and TX-MIX_Q. Consequently, in the mixing circuits TX-MIX_1 and TX-MIX_Q forming the transmission mixer 3021, the up conversion from the frequency of the analog baseband transmission signal to the frequency of the IF transmission signal is executed, and a single vector synthesized IF transmission signal is obtained from an adder 3033. The IF transmission signal from the adder 3033 is supplied to one input of a phase comparator PC forming the PM loop circuit 3022 (PM LP) used to transmit the phase modulated component from the RF transmission signal-signal processing sub-device 302 (TX SPU). In the PM loop circuit 3022 (PM LP), an output from the phase comparator PC is delivered to a control input of a transmission oscillator TXVCO via a charge pump CP and a low-pass filter LF. As an output from the transmission oscillator TXVCO is supplied to an input of a PM loop frequency down mixer DWN_MIX_PM, an IF transmission phase feedback signal from an output of the DWN_MIX_PM is obtained. When the transmission time slot adopts the GSM method, the IF transmission phase feedback signal is supplied to the other input of the phase comparator PC forming the PM loop circuit 3022 (PM LP) via the switch SW_1. Consequently, the transmission power signal from the output of the transmission RF power amplifier 203 contains precise phase modulation information of the GSM method. Meanwhile, when the transmission time slot adopts the GSM method, an output voltage Vramp from the ramp signal D-to-A converter 309 (Ramp DAC) inside the RF signal processing circuit 300 is supplied to a 10 MHz filter 315 via the switch SW_2. The amplification gain of the transmission RF power amplifier 203 is set to be proportional to the distance between the base station and the mobile communication terminal under the power supply voltage control or the bias voltage control using an automatic power control voltage Vapc from the filter 315.

On the contrary, when the transmission time slot adopts the EDGE method, the IF transmission signal from the adder 3033 contains not only the phase modulation information, but also the amplitude modulation information. Hence, in this case, not only is the IF transmission signal from the adder 3033 supplied to one input of the phase comparator PC forming the PM loop circuit 3022 (PM LP), but it is also supplied to one input of an amplitude comparator AC forming the AM loop circuit 3023 (AM LP). In this case, an output of the transmission oscillator TXVCO is not supplied to the other input of the phase comparator PC via the PM loop frequency down mixer DWN_MIX_PM. Instead, information about the transmission power of the transmission RF power amplifier 203 is supplied to the other input of the phase comparator PC via a power detector PDET, a variable gain circuit MVGA, and an AM loop frequency down mixer DWN_MIX_AM. The information about the transmission power of the transmission RF power amplifier 203 is also supplied to the other input of the amplitude comparator AC forming the AM loop circuit 3023 (AM LP) via the power detector PDET, the variable gain circuit MVGA, and the AM loop frequency down mixer DWN_MIX_AM. In the AM loop circuit 3023 (AM LP), an output from the amplitude comparator AC is supplied to the 10 MHz filter 315 via a low pass filter LF, a variable gain circuit IVGA, a voltage-to-current converter V/I, a charge pump CP, and the switch SW_2. Consequently, the transmission power signal as an output of the transmission RF power amplifier 203 that amplifies an RF oscillation output signal from the transmission oscillator TXVCO contains precise phase modulation information of the EDGE method first by the PM loop circuit 3022 (PM LP). The transmission power signal as an output of the transmission RF power amplifier 203 further contains precise amplitude modulation information of the EDGE method by the AM loop circuit 3023 (AM LP).

As the power detector PDET that detects transmission power of the transmission RF power amplifier 203, a coupler-detector that detects the transmission power of the RF power amplifier 203 in an electromagnetic or capacitive manner may be adopted. Besides this example, as the power detector PDET, a current sense detector may be adopted as well. The current sense detector allows a small detection DC or AC operating current proportional to a DC or AC operating current of the power amplifier element in the last stage of the RF power amplifier 203 to flow through a detection amplifier element.

In the RF signal processing integrated circuit 300 in FIG. 7, a control circuit 314 (CNTL) generates two control signals, so that the gains of the two variable gain circuits MVGA and IVGA forming the AM loop circuit 3023 (AM LP) responding to an output Vramp from the ramp signal D-to-A converter 309 (Ramp DAC) are in opposite directions. More specifically, the gain of the variable gain circuit IVGA increases when the gain of the variable gain circuit MVGA decreases in response to the output Vramp for a sum of the gains of the two variable gain circuits MVGA and IVGA to remain almost at a constant value. It is thus possible to reduce the occurrence of an event that a phase margin of the open loop frequency characteristic of the AM loop circuit 3023 becomes extremely small in response to the output Vramp.

As has been described, in comparison with the GSM method, in the EDGE method, not only the phase modulation information but also the amplitude modulation information is contained in both of a transmission and a reception. The control information when executing the operation setting of a time slot in the TDMA method is thus increased in the EDGE method in comparison with the GSM method. However, by adopting the second operation mode SOPMOD according to the preferred embodiment of the invention when communications of the EDGE method involving a larger volume of control information for the set operation of a time slot are supported, it is also possible to reduce the burden of a job of supplying various instruction codes and various kinds of control information to the transmission and reception control sub-device 310 inside the RF signal processing integrated circuit 300.

(Other Time Slot Setting)

FIG. 8 shows that it is also possible to book all the instructions and the related control information as well as the information about the execution order of plural instructions in the second operation mode SOPMOD even when the eighth time slot (SL 7) in the frame N−1 is in the monitor state (Mx), which is a virtual reception state other than the idle state (IDL). This is because an original job in the baseband signal processing LSI 400 is light also in the monitor state (Mx), which is a virtual reception state.

FIG. 9 shows that it is also possible to book all the instructions and the related control information as well as the information about the execution order of plural instructions in plural time slots in the preceding frame N and the succeeding frame N+1 even in the fifth time slot (SL 4) set in the idle state (IDL) in the preceding frame N.

While the inventions achieved by the inventors have been described concretely according to the embodiments, it goes without saying that the invention is not limited to these embodiments and can be modified in various manners without deviating from the scope of the invention.

For example, in the case of FIG. 7, the polar loop method is adopted, by which the amplification gain of the transmission RF power amplifier 203 is set through the power supply voltage control or the bias voltage control of the transmission RF power amplifier 203 using the automatic power control voltage Vapc from the filter 315 when the amplitude modulated component is transmitted in a transmission time slot of the EDGE method. However, the invention is not limited to the polar loop method, and it goes without saying that the polar modulator method can be adopted as well, by which a variable attenuator or a variable gain circuit is disposed at the input of the transmission RF power amplifier 203 to set the gain of the variable attenuator or the variable gain circuit using the automatic power control voltage Vapc from the filter 315.

Further, by improving the heat releasing structure of the package, it may be possible to integrate the transmission RF power amplifier 203 into an integrated circuit into which the baseband signal processing LSI 400, the application processor 510, and the RF signal processing unit 300 have been integrated.

What is claimed is:

1. An RF signal processing device serving as a second device that performs RF signal processing and is equipped to a mobile communication terminal capable of making communications with a base station by a communication method employing time-division multiple access by which each time slot among plural time slots is set in any one of an idle state, a reception operation from the base station, and a transmission operation to the base station, the second device being electrically connectable to a first device that performs baseband digital signal processing and is equipped to the mobile communication terminal,
wherein the second device has a first operation mode in which a setting operation of a time slot is executed using one time slot as one setting unit in response to information supplied from the first device, and a second operation mode in which a setting operation of a time slot is executed using plural time slots as one setting unit in response to information supplied from the first device, and
wherein the second device is selectively set in either one of the first operation mode and the second operation mode.

2. The RF signal processing device according to claim 1, wherein:
the second device includes an interface that receives the information supplied for the first operation mode and the information supplied for the second operation mode from the first device that performs the baseband digital signal processing.

3. The RF signal processing device according to claim 2, wherein:
the second device includes a memory that stores an instruction code and control information to execute an instruction for a set operation of a time slot, which are supplied as the information for the second operation mode from the first device that performs the baseband digital signal processing via the interface, and an RF signal processing sub-device that performs the RF signal processing; and
the setting operation of the time slot in the second operation mode is executed when the set operation of the time slot has been booked in the memory, by supplying from the first device, order information that determines in which order in the time slot the instruction code and the control information to execute the instruction booked in the memory are supplied to the RF signal processing sub-device.

4. The RF signal processing device according to claim 2, wherein:
the second device includes a memory that stores an instruction code and the control information to execute an instruction for a set operation of a time slot, which are supplied as the information for the second operation mode from the first device that performs the baseband digital signal processing via the interface, and an RF signal processing sub-device that performs the RF signal processing; and
the setting operation of the time slot in the second operation mode is executed when the set operation of the time slot has been booked in the memory, by supplying from the first device, timing information that determines at which timing in the time slot the instruction code and the control information to execute the instruction booked in the memory are supplied to the RF signal processing sub-device.

5. The RF signal processing device according to claim 2, wherein:
the second device includes a memory that stores an instruction code and the control information to execute an instruction for a set operation of a time slot, which are supplied as the information for the second operation mode from the first device that performs the baseband digital signal processing via the interface, and an RF signal processing sub-device that performs the RF signal processing; and
the setting operation of the time slot in the second operation mode is executed when the set operation of the time slot has been booked in the memory, by supplying from the first device, timing information that determines at which timing in the time slot the instruction code and the control information to execute the instruction booked in the memory are supplied to the RF signal processing sub-device.

6. The RF signal processing device according to claim 3, wherein:
the RF signal processing sub-device is furnished with a function of a reception operation from the base station and a function of a transmission operation to the base station conforming to both a GSM method and an EDGE method.

7. The RF signal processing device according to claim 6, wherein:
when the set operation of the time slot is set in the first operation mode, the instruction code and the control information to execute the instruction are supplied to the RF signal processing sub-device in order and at timing supplied from the first device.

8. The RF signal processing device according to claim 3, wherein:
setting bit information that sets the set operation of the time slot in either one of the first operation mode and the second operation mode is contained in the control information to execute the instruction.

9. The RF signal processing device according to claim 8, wherein:
the setting bit information is address information specifying plural registers forming the memory that stores the instruction code and the control information to execute the instruction.

10. A mobile communication terminal capable of making communications with a base station by a communication method employing time-division multiple access by which each time slot among plural time slots is set in any of an idle state, a reception operation from the base station, and a transmission operation to the base station,
wherein:
the mobile communication terminal has a first device that performs baseband digital signal processing and a second device that performs RF signal processing;
the second device has a first operation mode in which a setting operation of a time slot is executed using one time slot as one setting unit in response to information supplied from the first device, and a second operation mode in which the setting operation of the time slot is executed using plural time slots as one setting unit in response to information supplied from the first device; and
the second device is selectively set in either one of the first operation mode and the second operation mode.

11. The mobile communication terminal according to claim 10, wherein:
the second unit that performs the RF signal processing includes an interface that receives the information supplied for the first operation mode and the information supplied for the second operation mode from the first device that performs the baseband digital signal processing.

12. The mobile communication terminal according to claim 11, wherein:
the second device includes a memory that stores an instruction code and control information to execute an instruction for a set operation of a time slot, which are supplied as the information for the second operation from the first device that performs the baseband digital signal processing mode via the interface, and an RF signal processing sub-device that performs the RF signal processing; and
the setting operation of the time slot in the second operation mode is executed when the set operation of the time slot has been booked in the memory, by supplying from the first device, order information that determines in which order in the time slot the instruction code and the control information to execute the instruction booked in the memory are supplied to the RF signal processing sub-device.

13. The mobile communication terminal according to claim 11, wherein:
the second device includes a memory that stores the instruction code and the control information to execute an instruction for a set operation of a time slot, which are supplied as the information for the second operation mode from the first device that performs the baseband digital signal processing via the interface, and an RF signal processing sub-device that performs the RF signal processing; and
the setting operation of the time slot in the second operation mode is executed when the set operation of the time slot has been booked in the memory, by supplying from the first device, timing information that determines at which timing in the time slot the instruction code and the control information to execute the instruction booked in the memory are supplied to the RF signal processing sub-device.

14. The mobile communication terminal according to claim 11, wherein:
the second device includes a memory that stores the instruction code and the control information to execute an instruction for a set operation of a time slot, which are supplied as the information for the second operation mode from the first device that performs the baseband digital signal processing via the interface, and an RF signal processing sub-device that performs the RF signal processing; and
the setting operation of the time slot in the second operation mode is executed when the set operation of the time slot has been booked in the memory, by supplying from the first device, timing information that determines at which timing in the time slot the instruction code and the control information to execute the instruction booked in the memory are supplied to the RF signal processing sub-device.

15. The mobile communication terminal according to claim 12, wherein:
the RF signal processing sub-device is furnished with a function of a reception operation from the base station and a function of a transmission operation to the base station conforming to both a GSM method and an EDGE method.

16. The mobile communication terminal according to claim 15, wherein:
when the set operation of the time slot is set in the first operation mode, the instruction code and the control information to execute the instruction are supplied to the RF signal processing sub-device inside the second device in order and at timing supplied from the first device.

17. The mobile communication terminal according to claim 10, wherein:
setting bit information that sets the set operation of the time slot in either one of the first operation mode and the second operation mode is contained in the control information to execute the instruction.

18. The mobile communication terminal according to claim 17, wherein:
the setting bit information is address information specifying plural registers forming the memory that stores the instruction code and the control information to execute the instruction.
